(19) United States
(12) Patent Application Publication
(10) Pub. No.: US 2004/0144197 A1
(43) Pub. Date: Jul. 29, 2004

(54) Steering wheel covers

(76) Inventor: Patrick James O'Grady, Doncater (GB)

Correspondence Address: Richard A Giangiorgi Esq, Trexler Bushnell Giangiorgi Blackstone & Marr Ltd, 105 West Adams Street, Chicago, IL, 60603, US

(21) Appl. No.: 10/477,678

(22) PCT Filed: May 16, 2002
(86) PCT No.: PCT/GB02/02178

(30) Foreign Application Priority Data
May 18, 2001 (GB) 0112119.3

(51) Int. Cl. B62D 1/06

(52) U.S. Cl. 74/558

(57) ABSTRACT

The invention relates to steering wheel covers, of themselves known. Even covered steering wheels can be uncomfortable to touch in periods of cold weather and in predominantly cold climates. The invention seeks to remedy this, an objective met by a heatable cover comprising an elongate flexible laminated strip (1) of a length to encircle a steering wheel of a predetermined diameter, the strip having a width to encompass substantially the full periphery of the steering wheel, the laminated strip incorporating a flexible sheet (3) of electrically conductive and heatable material, and a number of spaced substantially parallel electrically conductive strips (4) on one side of the said flexible sheet and extending across the width thereof, said strips being connectable by live and return (8, 9) leads to a source of electrical power.

This invention relates to steering wheel covers.

Steering wheel covers of leather or synthetic plastics material have long been known, and positioned on a steering wheel, not only to improve appearance, but also for the added comfort of the driver.

In those circumstances where vehicles are used in cold climates, or during cold winter spells in otherwise moderate climates, even when a steering wheel cover is provided, the steering wheel can become uncomfortably cold, necessitating the use of gloves.

The objective of the invention is to overcome this disadvantage of known steering wheels.

According to a first aspect of the present invention a heatable cover for a steering wheel of a vehicle comprises an elongate flexible laminated strip of a length to encircle a steering wheel of a predetermined diameter, the strip having a width to encompass substantially the full periphery of the steering wheel, the laminated strip incorporating a flexible sheet of electrically conductive and heatable material, and a number of spaced substantially parallel electrically conductive strips on one side of the said flexible sheet and extending across the width thereof, said strips being connectable by live and return leads to a source of electrical power.

Preferably, the laminated strip is shaped to accommodate a predetermined steering wheel spoke arrangement.

According to a second aspect of the present invention, a heatable cover for a vehicle steering wheel comprises an elongate, flexible, laminated strip of a length to encircle a steering wheel of a predetermined diameter, the strip having a width to encompass substantially the full periphery of the steering wheel, and being shaped to accommodate a predetermined steering wheel spoke arrangement, the laminated strip incorporating a flexible sheet of electrically conductive and heatable material, a number of spaced substantially parallel flexible electrically conductive bars attached to one side of the said flexible sheet and extending across the width thereof, live and return electrical rails located to the opposite side of the said flexible sheet than the bars and electrical connections between the bars and the rails, a first electrically non-conductive but heat conductive elongate flexible strip interposed between the electrical rails and the said electrically conductive flexible sheet, and a second electrically non-conductive but heat conductive elongate flexible strip overlaying the live and return electrical rails. Preferably, the laminated strip has an elasticity such that it can be stretched and put into tight abutting contact with the whole of the surface of the steering wheel.

According to a third aspect of the present invention, the said live and return leads of the first aspect of the invention are conductive wires embedded in the steering wheel with connecting wires emerging from the steering wheel for connection to the electrically conductive strips.

Ideally, the flexible sheet of electrically conductive material is formed by a fabric coated with carbon particles dispersed in an elastomeric polymer provided with an anti-adsorption compound. Preferably, carbon is at a level of 20% to 75% by dry weight, to 80% to 25% by dry weight of elastomeric polymer.

By ensuring a uniform dispersal of carbon particles in the elastomeric polymer, a uniform conduction of electrical power is provided, with a consequent constant heating effect over the whole of the flexible sheet of electrically conductive material being enabled. The temperature to which the laminate can be raised and the speed of bringing the laminate to a predetermined temperature is, in part, a function of the depth of coating of carbon particles and elastomeric polymer applied to the fabric and, in part, a function of the spacing of the parallel bars.

To ensure a uniform thickness of coating, the carbon particle/elastomeric polymer mixture may be applied as a constant thickness layer on a release paper; the coated release paper and the fabric of the flexible sheet passed together through a press to impregnate and coat the fabric, and to subject the coated fabric to a controlled temperature rise to 110° C. to 150° C., to bring about a controlled release of solvents, and generate a coating substantially free from pinholes.

Steering wheel covers formed from the laminate discussed above can operate at ambient temperatures as low as −20%, and bring the steering wheel temperature to a pre-set level comfortable to the user, or to a temperature level selected by the user relatively quickly, and in a matter of a few minutes.

With the first and third aspects of the invention, the connecting wires emerging from the steering wheel are connected such as by soldering to the conductive strips on the flexible sheet of conductive material, the arrangement being such that alternate strips are connected to the live conductive wire and interposed strips connected to the return conductive wire, whereby to create a potential difference between adjacent strip to cause the flow of current through the conductive sheet and generate a required degree of heat.

With the second aspect of the invention it is preferred that the electrically non-conductive but heat conductive elongate flexible strip is of cotton or a cotton based material, on which the live and return electrical rails are provided, and by locating the rails towards the outer edges of the cotton or cotton based strip the parallel electrically conductive bars on the flexible strip heatable strip may have connectors that can engage over the interposed cotton or cotton based strip and be attached alternately to the respective live and return rail, to create a potential difference between adjacent bars and cause the flow of current through the conductive sheet.

The live and return rails may be formed by lengths of copper braid that can be attached to the surface of the first electrically non-conductive but heat conductive elongate flexible strip by an appropriate adhesive, and the ends of copper braid may be provided with electrical connections to a power source on the vehicle, such as the vehicle battery.

The live and return rails may be connected to the spaced substantially parallel, flexible electrically conductive bars by electrically conductive tape such as tinned copper tape attached by soldering and/or adhesive to the ends of the respective bars and the respective rail.

The strips or bars on the surface of the flexible sheet of electrically conductive and heatable material may be similarly preformed from any suitable electrically conductive material, and attached to the surface of the sheet by an appropriate adhesive; however, the strips or bars to one side of the flexible sheet, and the electrical rails to the opposite side of the electrically non-conductive but heat conductive elongate flexible strip (when provided) may each be formed by an electrically conductive ink appropriately sprayed or silk screen printed to the respective surface, and to which the ends of the electrically conductive tape can be soldered.

The ink may be a two-component silver filled polyurethane, and applied to the respective surface as a track through a screen of silk or nylon on which a stencil is provided. Once applied, the ink is cured, and has characteristics able to withstand the heat generated during the soldering of electrical connections.

For the comfort of the vehicle driver the laminate can be provided with a high density foam layer to overlie the cotton strip and to complete the laminate, an outer strip of electrically non-conductive but heat conductive foil-like material can be provided.

Thus, the laminate can be applied to a steering wheel and attached thereto by an inner adhesive layer of the laminate, overlying the surface of the flexible sheet of electrically conductive material, the laminate enveloping the entirety of the steering wheel. The electrical connections to the live and return rails can be passed through an attachment boss locating the steering wheel on the steering column, to pass down the steering column with other elements of the vehicles electrical loom, for connection to the vehicle battery via a strategically positioned ON/OFF switch accessible to the driver. Alternatively, or in addition to an ON/OFF switch, temperature sensitive means can be provided automatically when ambient temperature conditions are sensed to be below a pre-set threshold. Control means may also be provided, such that once the laminate has reached its predetermined temperature, it can be switched ON and OFF in accordance with a predetermined time cycle, to maintain the predetermined temperature. The laminate can then be encased in an outer cover of leather or appropriate synthetic plastics material for enhanced feel and for aesthetic appeal.

Alternatively, the heatable cover can be no more than a fabric strip with an applied electrically conductive sheet with conductive strips or bars, that, once applied to a steering wheel and connected to the live and return leads or rails, is overlaid by an outer cover of leather or appropriate synthetic plastics material for enhanced feel and aesthetic appeal.

Two embodiments of the invention will now be described with reference to the accompanying drawings, in which:

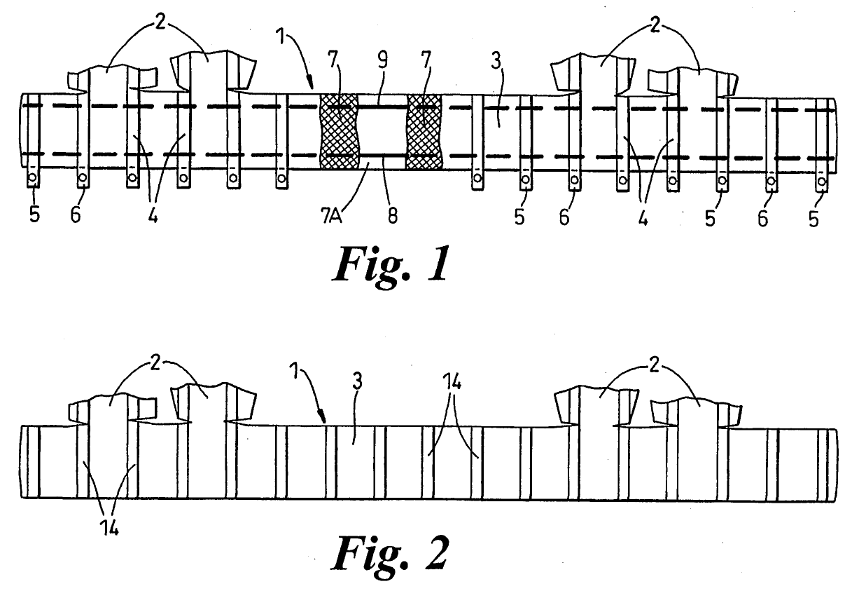

FIG. 1 is a front elevation of an elongate flexible laminated strip in accordance with a first aspect of the invention;

FIG. 2 corresponds to FIG. 1 but shows a second aspect of the invention;

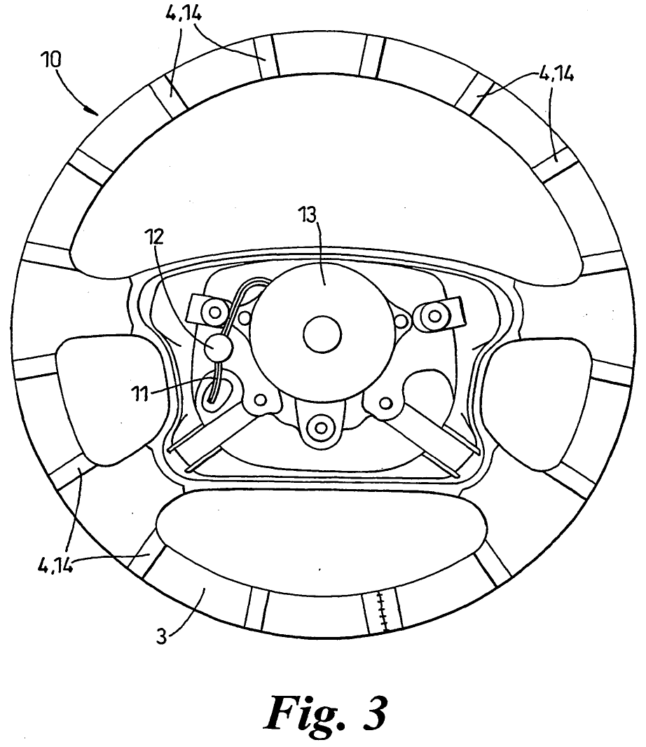

FIG. 3 is a front elevation of a steering wheel to which the strip of FIG. 1 or FIG. 2 has been applied;

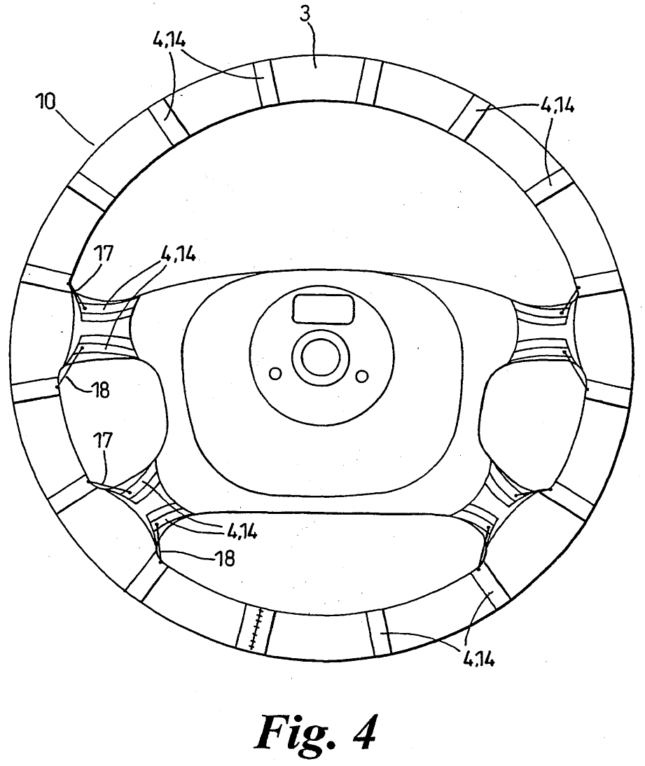

FIG. 4 is a rear elevation of the steering wheel of FIG. 3; and

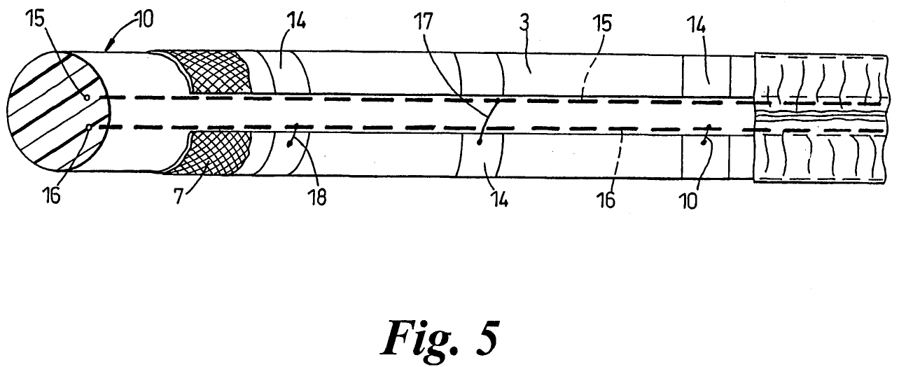

FIG. 5 is a side elevation of a part of a steering wheel to which the elongate flexible laminated strip has been applied, with parts removed.

In FIG. 1 an elongate flexible laminated strip 1 has a length and width to suit a particular steering Wheel, the strip having shaped sections 2 to accommodate the spoke pattern of the particular steering wheel, as is further illustrated in FIGS. 3 and 4. The strip 1 has a flexible sheet 3 of a conductive material as has hereinbefore been discussed, and to the flexible sheet, a number of spaced bars 4 are secured, the spaced bars being formed from any suitable flexible electrically conductive material, the bars having connecting sections 5, 6 extending beyond the edge of the strip. The flexible sheet 3 is applied to an electrically non-conductive but heat conductive fabric strip 7, such as for example cotton, and there being provided on the opposite side of the fabric strip live and return rails 8 and 9 of a flexible electrically conductive material, that may be overlaid by a second fabric sheet 7A. Although not shown, a second strip of non-electrically conductive fabric can overlay the live and return rails.

With the laminate applied to a steering wheel 10 as is illustrated in FIGS. 3 and 4, the connecting sections 5 of the bars 4 are folded over the fabric strip 7 to connect to the rail 8, and the alternate connecting sections 6 are overlaid by and connected to the rail 9.

The live and return rails have lead wires 11, as is shown in FIG. 3, the lead wires being connected to an electronic temperature control unit 12, and then to a connector 13 to the electrical supply on a vehicle, the connector 13 being of a known type that allows free rotation of the steering wheel without affecting the electrical connection to laminated strip 1.

In FIG. 2 is illustrated a second embodiment of the invention, where there is again a laminated strip formed from a flexible sheet 3 of electrically conductive material on a cotton fabric strip. Here, strips 14 of electrically conductive material are formed by an electrically conductive ink as has hereinbefore discussed, screen printed on to the surface of the flexible sheet. The laminated strip is applied to a steering wheel as is illustrated in FIGS. 3 and 4, but here, and as is illustrated in FIG. 5, live and return conductive wires 15 and 16 are moulded into the steering wheel during its manufacture, and connecting wires 17 and 18 are attached respectively to the live and return conductive wires, the connecting wires emerging from the surface of the steering wheel. With the laminated strip applied to a steering wheel, the connecting wires 17 of the conductive live wire 15 are attached such as by soldering to alternate strips 14, and the connecting wires 18 of the conductive return wire 16 connected to interposed strips 14. Here the emerging ends of the live and return leads serve as the lead wires 11 connected to the electronic temperature control unit 12.

An advantage of the second aspect of the invention is that the electrically conductive strips on the shaped sections 2 can have their own connecting wires extending to the live and return conductive wires 15, 16, to ensure that the heating effect around the spokes of the steering wheel is essentially similar to the heating effect around the steering wheel.

1. A heatable cover for a steering wheel of a vehicle characterised by an elongate flexible laminated strip (1) of a length to encircle a steering wheel (10) of a predetermined diameter, the strip having a width to encompass substantially the full periphery of the steering wheel, the laminated strip (1) incorporating a flexible sheet (3) of electrically conductive and heatable material, and a number of spaced substantially parallel electrically conductive strips (4, 14) on one side of the said flexible sheet and extending across the width thereof, said strips being connectable by live and return leads (8, 9, 15, 16) to a source of electrical power.

2. A heatable cover as in claim 2, characterised in that the laminate strip (1) is shaped (2) to accommodate a predetermined steering wheel spoke arrangement.

3. A heatable cover for a steering wheel of a vehicle characterised by an elongate, flexible, laminated strip (1) of a length to encircle a steering wheel (10) of a predetermined diameter, the strip having a width to encompass substantially the full periphery of the steering wheel, and being shaped (2) to accommodate a predetermined steering wheel spoke arrangement, the laminated strip incorporating a flexible sheet (3) of electrically conductive and heatable material, a number of spaced substantially parallel flexible electrically conductive bars (4) attached to one side of the said flexible sheet and extending across the width thereof, live and return electrical rails (8, 9) located to the opposite side of the said flexible sheet (3) than the bars and electrical connections (5, 6) between the bars and the rails, a first electrically non-conductive but heat conductive elongate flexible strip (7) interposed between the electrical rails and the said electrically conductive flexible sheet, and a second electrically non-conductive but heat conductive elongate flexible strip (7A) overlaying the live and return electrical rails.

4. A heatable cover as in claim 1 or claim 2, characterised in that the said live and return leads are conductive wires (15, 16) embedded in the steering wheel (10) with connecting wires (17, 18) emerging from the steering wheel for connection to the electrically conductive strips (14).

5. A heatable cover as in any of claims 1 to 4, characterised in that the flexible sheet (1) of electrically conductive material is formed by a fabric (7) coated with carbon particles dispersed in an elastomeric polymer provided with an anti-adsorption compound.

6. A heatable cover as in claim 5, characterised in that carbon is at a level of 20% to 75% by dry weight, to 80% to 25% by dry weight of elastomeric polymer.

7. A heatable cover as in any of claims 1 to 6, characterised in that the electrically non-conductive but heat conductive elongate strip (7) is of cotton or cotton based material.

8. A heatable cover as in claim 3 and any of claims 4 to 8 when appended to claim 3, characterised in that the spaced parallel electrically conductive bars (4) extend beyond one edge of the strip to provide connecting sections adjacent connecting sections being connected to the live and return electrical rails (8, 9) respectively.

9. A heatable cover as in claim 8, characterised in that the live and return rails (8, 9) are lengths of copper braid, the braid and the parallel conductive bars being attached to the laminated strip by an adhesive.

10. A heatable cover as in claim 1 and claims 3 to 9 when appended to claim 1, characterised in that the electrically conductive and parallel strips (14) are formed by electrically conductive ink.

11. A heatable cover as in claim 10, characterised in that the ink is a two-component silver filled polyurethane.

12. A heatable cover as in claim 10 or claim 11, characterised in that the ink is applied to the surface of the flexible sheet of electrically conductive material through a screen of silk or nylon on which a stencil is provided.

13. A heatable cover as in claim 0.4 or claim 5 to 12 when appended to claim 4, characterized in that the connecting wires (17, 18) extending from the live and return leads (15, 16) are connected to respective adjacent electrically conductive strips (14).

14. A heatable cover as in any of claims 1 to 13, wherein electrical connections to the rails or the embedded live and return leads extend to a temperature control device (12), in turn connected to a source of electrical supply on the vehicle.

15. A heatable cover as in claim 14, wherein the connection to the electrical supply is via a connector (13) that allows free rotation of the steering wheel whilst maintaining the electrical connection to the temperature control device and the laminated strip.
